(19) United States
(12) Patent Application Publication
(10) Pub. No.: US 2017/0171820 A1
(43) Pub. Date: Jun. 15, 2017

(54) A HIGH POWER RADIO BASE STATION, A LOW POWER RADIO BASE STATION AND RESPECTIVE METHOD PERFORMED THEREBY FOR COMMUNICATION WITH A WIRELESS DEVICE

(71) Applicant: TELEFONAKTIEBOLAGET LM ERICSSON (PUBL), Stockholm (SE)

(72) Inventors: Fredric KRONESTEDT, Bromma (SE); Magnus LUNDEVALL, Sollentuna (SE); Jari VIKBERG, Järna (SE)

(73) Assignee: TELEFONAKTIEBOLAGET L M ERICSSON (PUBL), Stockholm (SE)

(21) Appl. No.: 15/028,465

(22) PCT Filed: Jun. 16, 2015
(86) PCT No.: PCT/SE2015/050706

§ 371 Date: Apr. 11, 2016

(51) Int. Cl. H04W 52/02; H04W 52/04; H04W 92/20; H04W 52/10; H04W 84/04; H04W 24/02; H04W 52/08

(52) U.S. Cl. CPC H04W 52/0245; H04W 24/02; H04W 52/0203; H04W 52/0209; H04W 52/0235; H04W 52/0229; H04W 52/0219; H04W 52/04; H04W 52/08; H04W 52/10; H04W 84/045; H04W 92/20

(57) ABSTRACT

A high power RBS and a low power RBS as well as respective methods performed thereby for communicating with a wireless device are provided. The method performed by the high power RBS comprises determining transport characteristic(s) between the high power RBS and the low power RBS. When the determined transport characteristic(s) are favourable, the method comprises transmitting control information to the wireless device on a first set of licensed frequency bands or on a second set of licensed frequency bands being different than the first set of licensed frequency bands. When the determined transport characteristic(s) are unfavourable, the method comprises refraining from transmitting data and the control information to the wireless device on the second set of licensed frequency bands allowing the low power RBS to transmit the control information on the second set of licensed frequency bands.

### TECHNICAL FIELD

The present disclosure relates to wireless communication and in particular to a high power RBS and a low power RBS and respective methods performed thereby for communication with a wireless device.

### BACKGROUND

To cope with increasing mobile traffic demands and higher expectations for better user experience, macro cells (i.e. cells of high power Radio Base Stations, RBSs) are complemented with small cells (i.e. cells of low power RBSs) and in particular indoor small cells or indoor systems like e.g. Radio Dot Systems, RDS and Distributed Antenna Systems, DAS, since the majority of mobile traffic is generated in indoor locations. It is often mentioned that 70-80% of traffic demand comes from indoor areas. Enterprise services are moreover being proposed by operators, offering companies and its employees a solution with range of services and wireless access in their premises. Compared to traditional mobile broadband services, it is expected that enterprise services would target much higher capacity (data demand per user) and user experience targets. For example, enterprise users should get unlimited data when in the office. This is typically not the case for mobile broadband services where user data volumes are limited per month.

Wireless communications use both licensed and unlicensed spectrum. 3^{rd} Generation Partnership Project, 3GPP, technologies typically use licensed spectrum where a single operator uses a part of the licensed spectrum in a country or other area. Unlicensed spectrum is available for e.g. Wi-Fi, and it can be used by several parties and operators in the same area. Sharing rules and techniques are employed in order to avoid uncoordinated interference between the users. Due to output power limitations and regulations, the unlicensed spectrum is in many cases useful only in indoor locations.

It is being discussed to use Long Term Evolution, LTE, in unlicensed bands (e.g. 5 GHz), so called licensed assisted access where unlicensed spectrum is used for data transmissions in combination with a licensed spectrum part used for control signalling.

Evolved Packet System, EPS, is the Evolved 3GPP Packet Switched Domain and consists of Evolved Packet Core, EPC, and Evolved Universal Terrestrial Radio Access Network, E-UTRAN.

FIG. 1a is an overview of the EPC architecture. This architecture is defined in 3GPP TS 23.401. The LTE radio access, E-UTRAN, comprises of one more eNodeBs, eNBs.

FIG. 1b shows the overall E-UTRAN architecture and is further defined in for example 3GPP TS 36.300. The E-UTRAN comprises eNBs, providing the E-UTRA user plane (Packet Data Convergence Protocol, PDCP, /Radio Link Control, RLC, /Media Access Control, MAC, /Physical layer, PHY,) and control plane (Radio Resource Control, RRC, in addition to the above user plane protocols) protocol terminations towards the User Equipment, UE. The eNBs are interconnected with each other by means of the X2 interface. The eNBs are also connected by means of the S1 interface to the EPC, more specifically to the Mobility Management Entity, MME, by means of the S1-MME interface and to the Serving Gateway, S-GW, by means of the S1-U interface.

The main parts of the EPC Control Plane (CP) and User Plane (UP) architectures are shown in FIGS. 1c and 1d.

The eNB control and user plane protocols and related functionality can be deployed in different ways. In one example, all the protocol layers and related functionality is deployed in the same physical node including the antenna. One example of this is a so called Pico or Femto eNodeB, or more generally low power RBS. Another deployment example is a so called Main-Remote split. In this case the eNodeB is divided into Main Unit and Remote Unit that may also be called as Digital Unit, DU, and Remote Radio Unit, RRU, respectively. The Main Unit contains all the protocol layers, except the lower parts of the PHY layer that are instead placed in the Remote Radio Unit. The split in the PHY-layer is at the time domain (IQ) data level (after/before Inverse Fast Fourier Transform, IFFT, /FFT and Cyclic Prefix, CP, insertion/removal) that is forwarded from the Main Unit to the Remote Radio Unit over so called Common Public Radio Interface, CPRI-interface, (high speed, low latency data interface). The Remote Radio Unit then performs the needed Digital-to-Analog, DAC, conversion to create analogue Radio Frequency data, RF-data, power amplifies and forwards the analogue RF data to the antenna.

The LTE Rel-10 specifications have been standardised, supporting Component Carrier, CC, bandwidths up to 20 MHz (which is the maximal LTE Rel-8 carrier bandwidth). An LTE Rel-10 operation wider than 20 MHz is possible and appear as a number of LTE CCs to an LTE Rel-10 terminal. The straightforward way to obtain bandwidths wider than 20 MHz is by means of Carrier Aggregation, CA. CA implies that an LTE Rel-10 terminal can receive multiple CC, where the CC have, or at least the possibility to have, the same structure as a Rel-8 carrier.

The Rel-10 standard support up to 5 aggregated CCs where each CC is limited in the RF specifications to have a one of six bandwidths namely 6, 15, 25, 50, 75 or 100 RB (corresponding to 1.4, 3, 5, 10, 15 and 20 MHz respectively).

The number of aggregated CCs as well as the bandwidth of the individual CCs may be different for uplink and downlink. A symmetric configuration refers to the case where the number of CCs in downlink (DL) and uplink (UL) is the same whereas an asymmetric configuration refers to the case that the number of CCs is different in DL and UL. It is important to note that the number of CCs configured in the network may be different from the number of CCs seen by a terminal: A terminal may for example support more downlink CCs than uplink CCs, even though the network offers the same number of uplink and downlink CCs.

CCs are also referred to as cells or serving cells. More specifically, in an LTE network the cells aggregated by a terminal are denoted primary Serving Cell, PCell, and secondary Serving Cells, SCells. The term serving cell comprises both PCell and SCells. All UEs have one PCell and which cell is a UEs PCell is terminal specific and is considered “more important”, i.e. vital control signalling and other important signalling is typically handled via the PCell. Uplink control signalling is always sent on a UEs PCell. The component carrier configured as the PCell is the primary CC whereas all other component carriers are secondary serving cells. The UE can send and receive data both on the PCell and SCells. For control signalling such as scheduling commands this could either be configured to only be transmitted and received on the PCell but where the commands are also valid for SCell, or it can be configured to be transmitted and received on both PCell and SCells. Regardless of the mode of operation, the UE will only need to read the broadcast channel in order to acquire system information parameters on the Primary Component Carrier, PCC. System information related to the Secondary Component Carriers, SCCs, may be provided to the UE in dedicated RRC messages.

During initial access a LTE Rel-10 terminal behaves similar to a LTE Rel-8 terminal. However, upon successful connection to the network a Rel-10 terminal may—depending on its own capabilities and the network—be configured with additional serving cells in the UL and DL. Configuration is based on RRC. Due to the heavy signalling and rather slow speed of RRC signalling it is envisioned that a terminal may be configured with multiple serving cells even though not all of them are currently used.

There are different deployment scenarios for CA in relation to frequency bands, and the placement of cells within frequency bands. The different variants are i) intra-band aggregation, contiguous cells, ii) intra-band aggregation, non-contiguous cells and iii) inter-band aggregation. The different frequency bands are typically part of licensed spectrum.

To summarise, LTE CA supports efficient use of multiple carriers, allowing data to be sent/received over all carriers. There is support for cross-carrier scheduling avoiding the need that the UE listen to all carrier-scheduling channels all the time. The solution relies on tight time synchronisation between the carriers. The synchronisation requirements impact the different deployment possibilities. When it comes to the Main-Remote deployment, there are different possibilities on how CA can be deployed either within a DU or between different DUs. It is possible to both have Intra-DU CA meaning that the PCell and all the SCell(s) are controlled by the same DU. Inter-DU CA, on the other hand, means that the PCell and SCell(s) may be controlled by different DUs.

LTE Licensed Assisted Access, LTE LAA, is shortly about applying LTE CA also for unlicensed spectrum. The main driver is assumed high availability of unlicensed spectrum globally and especially used for small cells, i.e. cells of low power RBSs. Unlicensed spectrum is used as a performance booster managed by a licensed carrier in LTE LAA. The PCell is always in the licensed spectrum and the SCell may use unlicensed bands (in addition to or without SCell(s) on licensed bands). LAA-LTE is a variant of inter-band aggregation. LTE LAA is also called LTE-Unlicensed, LTE-U, and both terms are used in this disclosure.

When deploying indoor solutions in an enterprise building, it can be difficult and costly to achieve indoor dominance, i.e. that the indoor system provides stronger signal inside the building than outdoor macro. Indoor dominance is required to connect indoor users to the indoor system when a small cell selection offset is used. In LTE, a cell selection offset of up to 9 dB is possible but in many cases the difference between macro and indoor signals can be much larger. The reason is that the macro uses much higher power (e.g. 60-80 W) than indoor small cells (<1 W). There can also be line-of-sight propagation from the macro towards the building or a low building penetration loss that increase this effect. The indoor small cells also use limited power to avoid radiation effects since users can be very close to the small cell antenna. The lack of indoor dominance will cause the indoor users to be connected to the macro system in these areas. As a result, there will be a negative impact on the macro capacity since the enterprise users are expected to demand a high amount of data due to the unlimited data service offerings (normally part of enterprise offerings). This will affect all users connected to the macro, i.e. regular mobile broadband service users not connected to indoor system. A deployment of an indoor low power RBS and an outdoor high power RBS is schematically illustrated in FIG. 1e.

### SUMMARY

The object is to obviate at least some of the problems outlined above. In particular, it is an object to provide a high power RBS, a low power RBS and respective methods performed by the high power and low power RBS respectively for communicating with a wireless device. These objects and others may be obtained by providing a high power RBS and a low power RBS and a method performed by a high power RBS and a low power RBS according to the independent claims attached below.

According to an aspect a method performed by a high power RBS for communicating with a wireless device is provided. The high power RBS is operable in a wireless communication network supporting Carrier Aggregation and the high power RBS is associated with a low power RBS. The method comprises determining transport characteristic(s) between the high power RBS and the low power RBS. When the determined transport characteristic(s) are favourable, the method comprises transmitting control information to the wireless device on a first set of licensed frequency bands or on a second set of licensed frequency bands being different than the first set of licensed frequency bands. When the determined transport characteristic(s) are unfavourable, the method comprises refraining from transmitting data and the control information to the wireless device on the second set of licensed frequency bands allowing the low power RBS to transmit the control information on the second set of licensed frequency bands.

According to an aspect, a method performed by a low power RBS for communicating with a wireless device is provided. The low power RBS is operable in a wireless communication network supporting Carrier Aggregation and the low power RBS is associated with a high power RBS. The method comprises determining transport characteristic(s) between the high power RBS and the low power RBS. When the determined transport characteristic(s) are unfavourable, the method comprises transmitting control information to the wireless device, the control information being transmitted on a second set of licensed frequency bands which is different from a first set of licensed frequency bands of the high power RBS. The method further comprises, when the determined transport characteristic(s) are favourable, refraining from transmitting the control information to the wireless device allowing the high power RBS to transmit the control information on the first or the second set of licensed frequency bands.

According to an aspect, a high power RBS for communicating with a wireless device is provided. The high power RBS is operable in a wireless communication network supporting Carrier Aggregation and the high power RBS is associated with a low power RBS. The high power RBS is configured for determining transport characteristic(s) between the high power RBS and the low power RBS. When the determined transport characteristic(s) are favourable, the method comprises transmitting control information to the wireless device on a first set of licensed frequency bands or on a second set of licensed frequency bands being different than the first set of licensed frequency bands. When the determined transport characteristic(s) are unfavourable, the method comprises refraining from transmitting data and the control information to the wireless device on the second set of licensed frequency bands allowing the low power RBS to transmit the control information on the second set of licensed frequency bands.

According to an aspect, a low power RBS for communicating with a wireless device is provided. The low power RBS is operable in a wireless communication network supporting Carrier Aggregation and the low power RBS is associated with a high power RBS. The low power RBS is configured for determining transport characteristic(s) between the high power RBS and the low power RBS. When the determined transport characteristic(s) are unfavourable, the method comprises transmitting control information to the wireless device, the control information being transmitted on a second set of licensed frequency bands which is different from a first set of licensed frequency bands of the high power RBS. The method further comprises, when the determined transport characteristic(s) are favourable, refraining from transmitting the control information to the wireless device allowing the high power RBS to transmit the control information on the first or the second set of licensed frequency bands.

The high power RBS, the low power RBS and the respective method performed by the high power RBS and the low power RBS have several possible advantages. One possible advantage is that high indoor capacity may be maintained without negatively affecting the surrounding high power RBS capacity. The cost for deploying the indoor system (or number of indoor small cells) can be minimised since full indoor dominance is provided by using a small part of “dedicated” indoor spectrum. The solution provides coordination between high power RBS and low power RBS and it is achieved by serving indoor users in non-indoor dominance area using unlicensed spectrum. The reduction in efficiency of the licensed spectrum is minimised since the licensed spectrum is reused as efficiently as possible, considering the transport characteristic between baseband units.

### BRIEF DESCRIPTION OF DRAWINGS

Embodiments will now be described in more detail in relation to the accompanying drawings, in which:

FIG. 1a is an illustration of non-roaming EPC architecture.

FIG. 1b is an illustration of the overall E-UTRAN architecture.

FIG. 1c is an illustration of EPC control plane protocol architecture.

FIG. 1d is an illustration of EPC user plane protocol architecture.

FIG. 1e is an illustration of an indoor low power RBS and an outdoor high power RBS.

FIG. 2a is a flowchart of an embodiment of a method performed by a high power RBS for communicating with a wireless device according to an exemplifying embodiment.

FIG. 2b is a flowchart of another embodiment of a method performed by a high power RBS for communicating with a wireless device according to an exemplifying embodiment.

FIG. 3a is a flowchart of an embodiment of a method performed by a low power RBS for communicating with a wireless device according to an exemplifying embodiment.

FIG. 3b is a flowchart of an embodiment of a method performed by a low power RBS for communicating with a wireless device according to another exemplifying embodiment.

FIG. 3c is a flowchart of an embodiment of a method performed by a low power RBS for communicating with a wireless device according to yet another exemplifying embodiment.

FIG. 4a is a schematic illustration of an arrangement used when there is an unfavourable transport characteristics between digital units of a low power RBS and a high power RBS.

FIG. 4b is a schematic illustration of an arrangement used when there is a favourable transport characteristics between digital units of a low power RBS and a high power RBS.

FIG. 5 is a block diagram of a high power RBS for communicating with a wireless device according to an exemplifying embodiment.

FIG. 6 is a block diagram of a high power RBS for communicating with a wireless device according to another exemplifying embodiment.

FIG. 7 is a block diagram of a low power RBS for communicating with a wireless device according to another exemplifying embodiment.

FIG. 8 is a block diagram of a low power RBS for communicating with a wireless device according to an exemplifying embodiment.

FIG. 9 is a block diagram of an arrangement in a high power RBS for communicating with a wireless device according to an exemplifying embodiment.

FIG. 10 is a block diagram of an arrangement in a low power RBS for communicating with a wireless device according to an exemplifying embodiment.

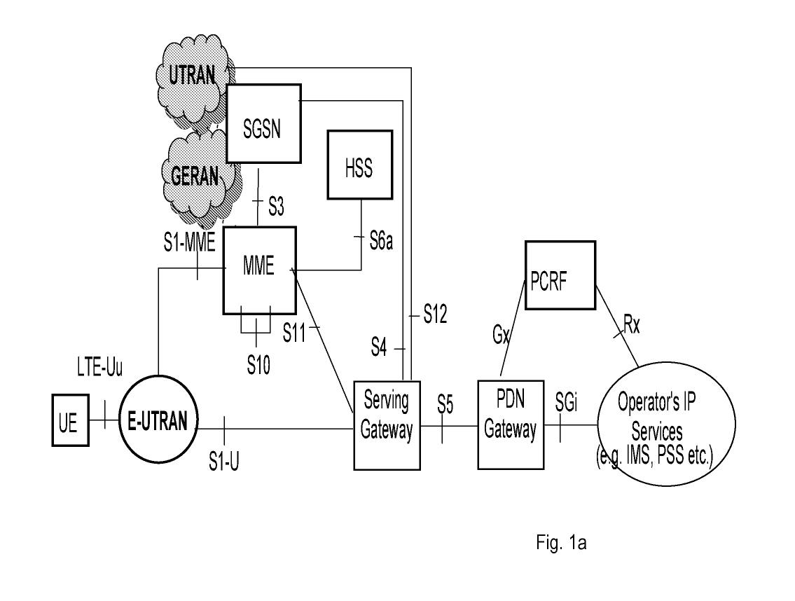

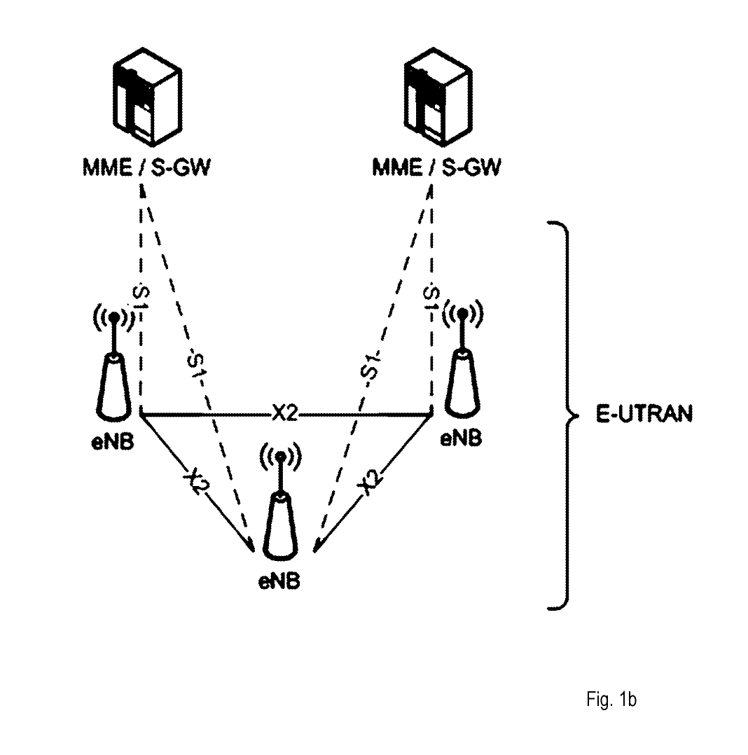

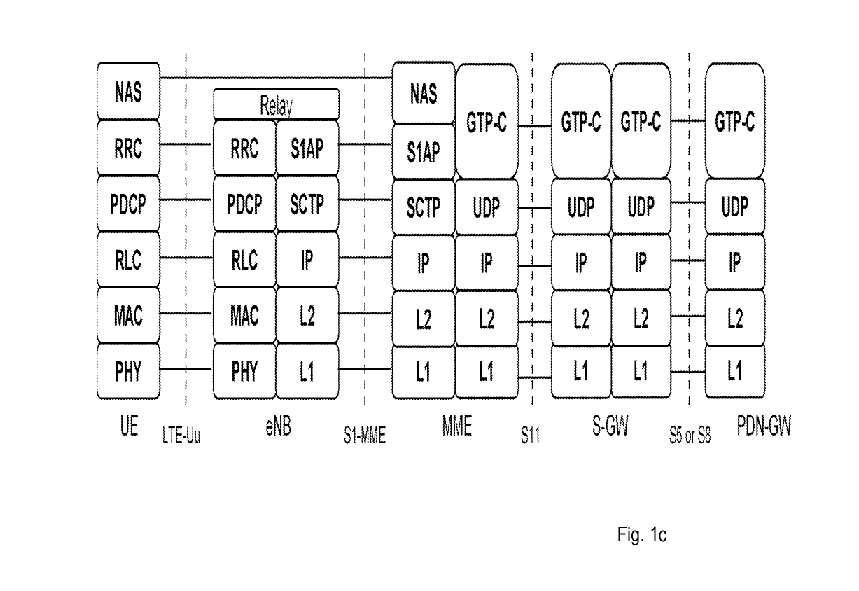

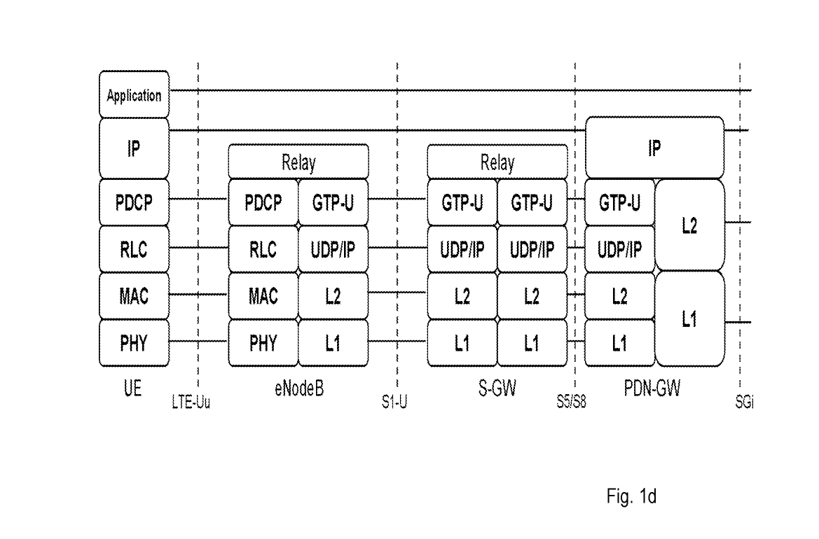

### DETAILED DESCRIPTION

Briefly described, a high power RBS and a low power RBS as well as respective methods performed thereby for communicating with a wireless device are provided. The high power RBS and the low power RBS are operable in a wireless communication network supporting Carrier Aggregation and the high power RBS is associated with the low power RBS. By determining transport characteristic(s) between the high power RBS and the low power RBS and the dominance situation for the wireless device, the RBSs determine which one shall send control information to the wireless device and which one shall send data to the wireless device. Dominance problem may be expressed as: received signal strength of low power RBS signals <received signal strength of high power RBS signals=dominance problem.

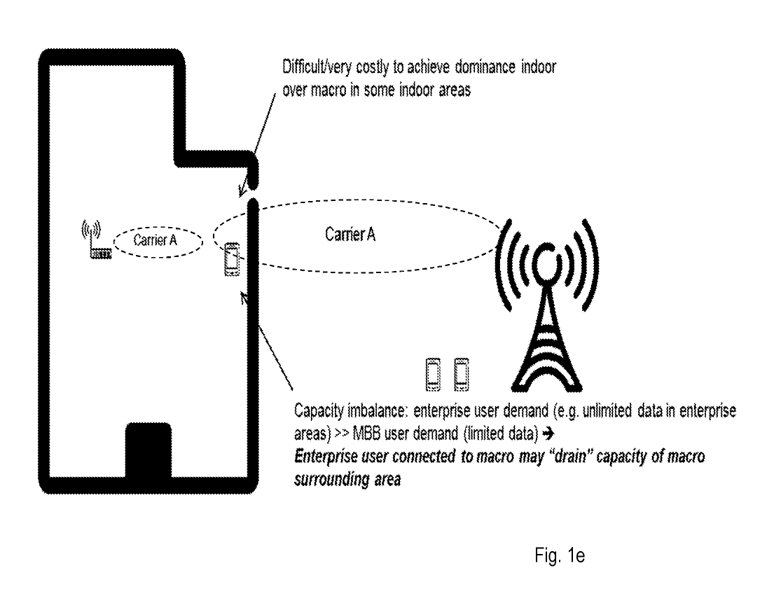

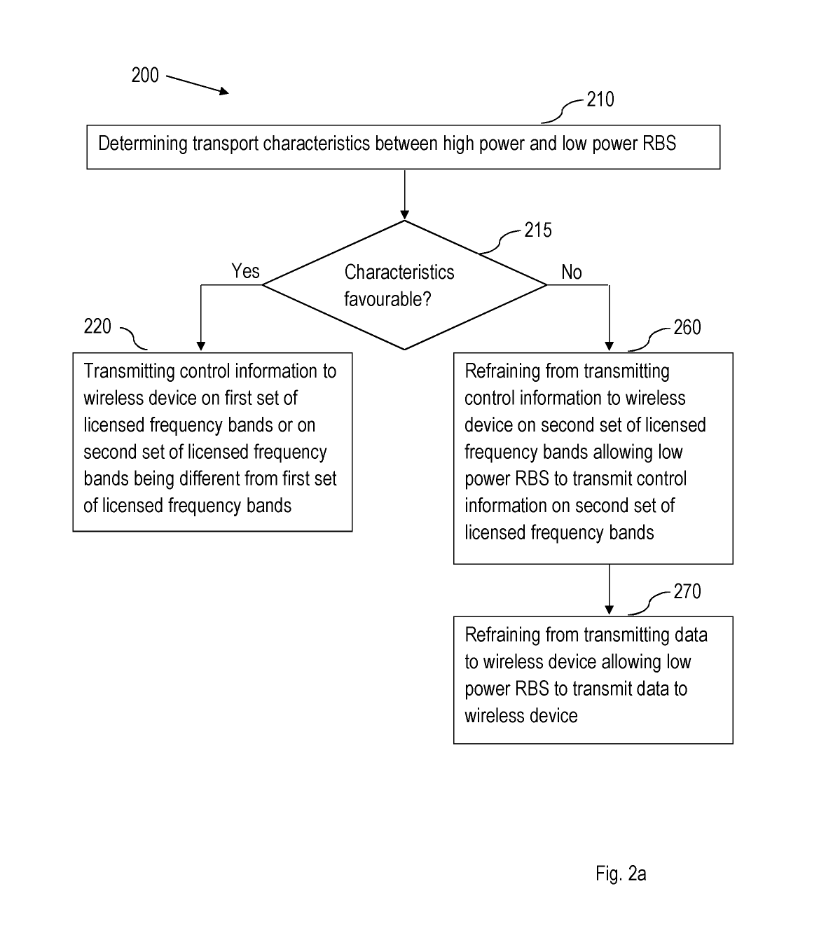

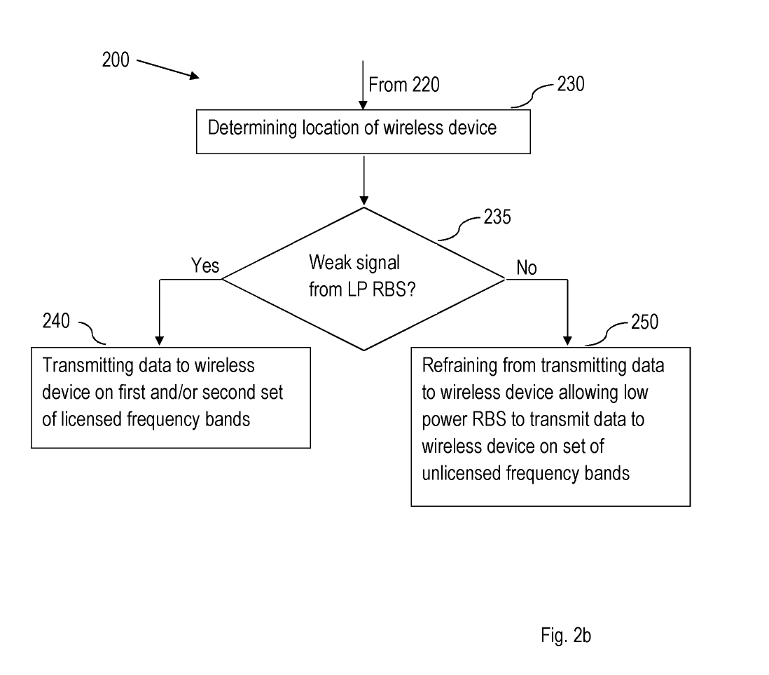

Embodiments herein relate to a method performed by a high power RBS for communicating with a wireless device. The high power RBS is operable in a wireless communication network supporting Carrier Aggregation and the high power RBS is associated with a low power RBS. Embodiments of such a method will now be described with reference to FIGS. 2a and 2b.

FIG. 2a illustrates the method 200 comprising determining 210 transport characteristic(s) between the high power RBS and the low power RBS. When the determined transport characteristic(s) are favourable, the method comprises transmitting 220 control information to the wireless device on a first set of licensed frequency bands or on a second set of licensed frequency bands being different than the first set of licensed frequency bands. When the determined transport characteristic(s) are unfavourable, the method comprises refraining 260 from transmitting the control information to the wireless device on the second set of licensed frequency bands allowing the low power RBS to transmit the control information on the second set of licensed frequency bands.

There are many possible definitions of transport characteristic(s) being favourable and unfavourable. One example is that transport characteristics refer to a delay on a backhaul between the high power RBS and the low power RBS. In order for the transport characteristics to be favourable, the delay is less than a delay threshold. When the delay equals or is above the delay threshold, i.e. the delay is longer than the time specified by the threshold, the transport characteristics is unfavourable. Other examples of transport characteristics are delay variation, available bandwidth and time synchronisation (e.g. being more or less than 1.5 μs).

The method comprises determining transport characteristic(s) between the high power RBS and the low power RBS. This can also be done in different ways. In one example, it is determined by another network node and signalled, or indicated, to the high power RBS. In this example, determining the transport characteristic(s) comprises receiving the signalling, or indication from the network node informing the high power RBS about the transport characteristic(s) between the high power RBS and the low power RBS. In another example, the high power RBS measures the transport characteristic(s) between the high power RBS and the low power RBS itself and thereby determines the transport characteristic(s). FIG. 2a also comprises a box 215, which illustrates the high power RBS checking if the transport characteristic(s) are favourable or unfavourable.

Depending on the whether the transport characteristic(s) are favourable or unfavourable, e.g. if the delay is shorter or longer than the time specified by the delay threshold, the high power RBS takes different actions. In case the transport characteristic(s) are favourable, the first and second licensed bands are available in both a cell of high power RBS and a cell of the low power RBS. An RBS may have one or more cells, wherein a cell is at least a part of a coverage area of the RBS. Thus, when the transport characteristic(s) are favourable, the high power RBS transmits control information to the wireless device on a first set of licensed frequency bands or on a second set of licensed frequency bands being different than the first set of licensed frequency bands. When the first and second licensed bands are available in both a cell of high power RBS and a cell of the low power RBS, it is possible to transmit control information on either of the first and second licensed bands. However, the high power RBS transmits the control information to the wireless device on a first set of licensed frequency bands. The first set of frequency bands may be a Primary Serving Cell. When the transport characteristic(s) are favourable, e.g. when the delay on the backhaul is shorter than a certain time, i.e. the value or length of the delay threshold, the high power RBS and the low power RBS may communicate with each other in an efficient way. In other words, they may coordinate between each other such that the high power RBS may send control information and the low power RBS may possible send data to the wireless device.

However, in case the determined transport characteristic(s) are unfavourable, the method comprises refraining 260 from transmitting the control information to the wireless device on the second set of licensed frequency bands allowing the low power RBS to transmit the control information on the second set of licensed frequency bands. When the transport characteristic(s) are unfavourable, e.g. when the delay on the backhaul is longer than a certain time, i.e. the value or length of the delay threshold, the high power RBS and the low power RBS may not communicate with each other in an efficient way. Thus, the high power RBS refrains from transmitting anything to the wireless device, i.e. the high power RBS refrains from transmitting control information to the wireless device. This enables, or allows, the low power RBS to serve the wireless device by transmitting the control information on the second set of licensed frequency bands. The manner in which the low power RBS transmits control information to the wireless device will be described in more detail below.

The method performed by the high power RBS has several advantages. One possible advantage is that high indoor capacity may be maintained without negatively affecting the surrounding high power RBS capacity. The cost for deploying the indoor system (or number of indoor small cells) can be minimised since full indoor dominance is provided by using a small part of “dedicated” indoor spectrum. The solution provides coordination between high power RBS and low power RBS and it is achieved by serving indoor users in non-indoor dominance area using unlicensed spectrum. The reduction in efficiency of the licensed spectrum is minimised since the licensed spectrum is reused as efficiently as possible, considering the transport characteristic between baseband units.

According to an embodiment, illustrated in FIG. 2b, the method 200 further comprises when the determined transport characteristic(s) are favourable: determining 230 a location of the wireless device, and when the wireless device is located in an area associated with weak signal from low power RBS: transmitting 240 data to the wireless device, the data being transmitted on the first and/or second set of licensed frequency bands.

When the determined transport characteristic(s) are favourable, the high power RBS and the low power RBS may communicate efficiently and coordinate possible activities, such as e.g. the high power RBS transmitting the control information and the low power RBS transmitting data to the wireless device. However, depending on if the wireless device is located in an area associated with dominance problems, i.e. an area where the low power RBS does not provide a stronger signal than the high power RBS, the low power RBS may not be suitable to transmit the data even if the transport characteristic(s) are favourable. If the transport characteristic(s) are favourable, i.e. the high power RBS and the low power RBS may communicate efficiently and coordinate possible activities, but the signal(s) from the low power RBS is weak, the low power RBS may not be suitable for transmitting the data to the wireless device. The data may have a high probability of being corrupted due to e.g. interference since the signal(s) from the low power RBS is/are weak.

Consequently, even if the determined transport characteristic(s) are favourable, but the wireless device is located in an area associated with weak signal from low power RBS, the high power RBS transmits data to the wireless device, the data being transmitted on the first and/or second set of licensed frequency bands. Since the first and second bands are available in both a cell of the high power RBS and a cell of the low power RBS, the data can be transmitted on either bands or both.

Determining whether the wireless device is located in an area associated with dominance problems may be performed by means of well-known methods. For example, the wireless device may measure received signal strength of signals received from the high power RBS and the low power RBS. The wireless device may further send measurement reports, e.g. to the high power RBS, indicating the received signal strength of respective RBSs the wireless device can “hear”. By evaluating the received measurement reports, the high power RBS may determine if the wireless device is located in an area associated with dominance problems or not. In other words, determining 230 the location of the wireless device may comprise in one embodiment determining whether the wireless device is located in an area associated with dominance problems or is located in an area not associated with dominance problems. Thus, an exact geographical location is not determined, but it is determined if the wireless device is located in an area associated with dominance problems or not.

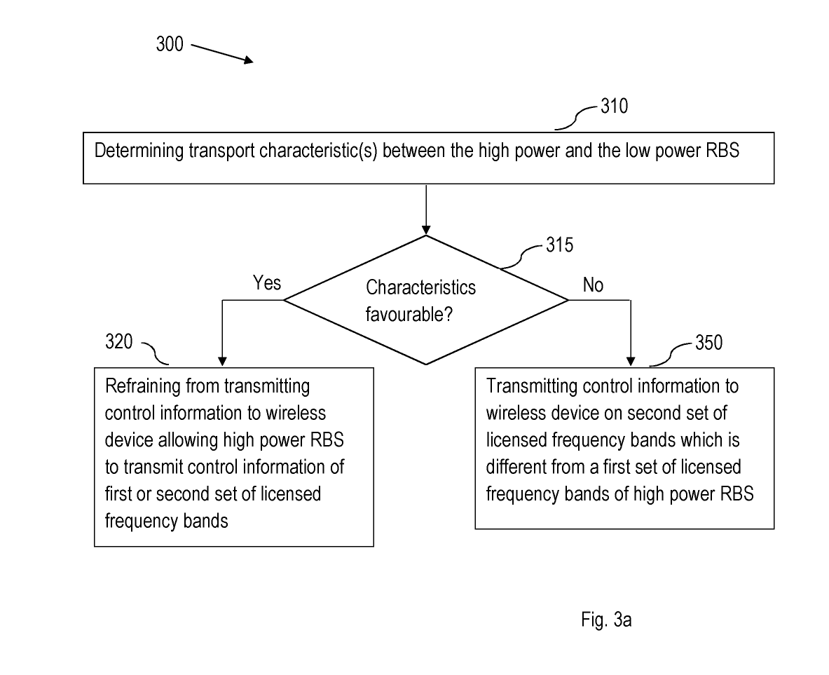

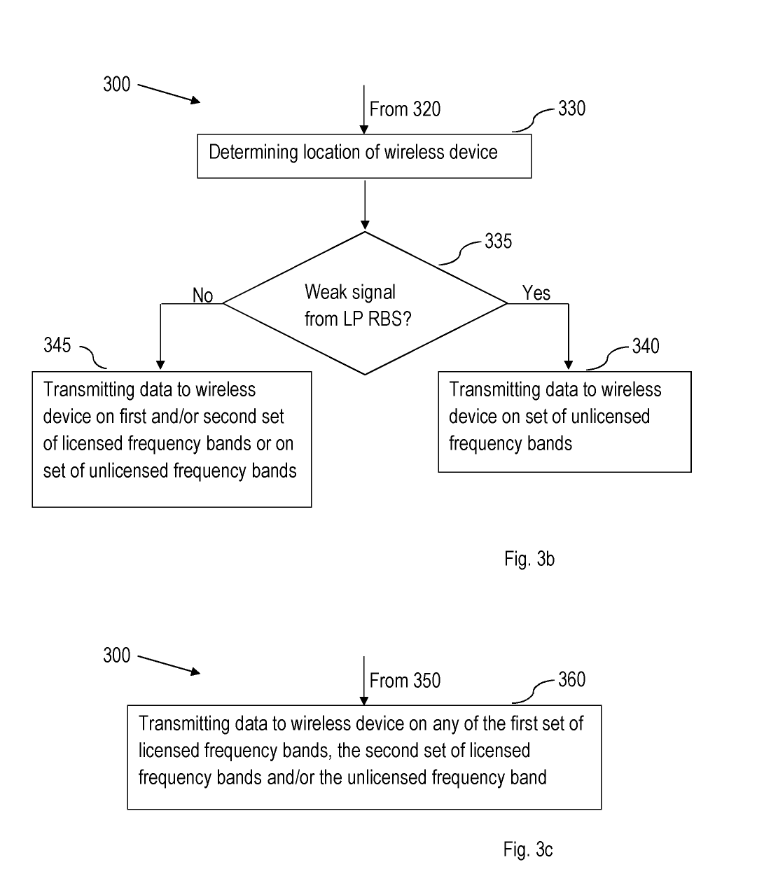

FIG. 2b also comprises a box 235, which illustrates the high power RBS checking if the signal from the low power (LP) RBS is weak or not. It shall be pointed out that “weak signal from low power RBS” in the context of this disclosure means weak signal from the low power RBS and strong signal from the high power RBS, which means that there is a dominance problem, wherein the low power RBS may not achieve dominance in its cell, i.e. its coverage area. In other words: received signal strength of low power RBS signals <received signal strength of high power RBS signals=dominance problem. Consequently, with the expression “weak signal from LP RBS” in FIGS. 2b and 3b is meant an area associated with dominance problem(s).

The method may further comprise, when the determined transport characteristic(s) are favourable: when the wireless device is located in an area associated with strong signal from the low power RBS: refraining 250 from transmitting data to the wireless device allowing the low power RBS to transmit the data to the wireless device on a set of unlicensed bands.

In the case when the determined transport characteristic(s) are favourable, the high power RBS transmits control information to the wireless device. If the wireless device is located in an area associated with strong signal from the low power RBS, i.e. an area not associated with dominance problems, the low power RBS may successfully transmit data to the wireless device without a high risk of interference. Consequently, the high power RBS refrains from transmitting data to the wireless device thereby allowing the low power RBS to transmit the data to the wireless device on a set of unlicensed bands.

The manner in which the low power RBS may transmit data to the wireless device will be explained in more detail below.

Still further, the method may comprise, as illustrated in FIG. 2a, when the determined transport characteristic(s) are unfavourable: refraining 270 from transmitting data to the wireless device allowing the low power RBS to transmit the data to the wireless device.

As described above, when the determined transport characteristic(s) are unfavourable, the high power RBS and the low power RBS may not efficiently communicate with each other to coordinate different actions between each other. Thus, the high power RBS refrains from transmitting control information to the wireless device. Still further, the high power RBS also refrains 270 from transmitting data to the wireless device and leaves it up to the low power RBS to transmit both control information and data to the wireless device

Embodiments herein also relate to a method performed by a low power RBS for communicating with a wireless device. The low power RBS is operable in a wireless communication network supporting Carrier Aggregation and the low power RBS is associated with a high power RBS. Embodiments of such a method will now be described with reference to FIGS. 3a-3c.

FIG. 3a illustrates the method 300 comprising determining 310 transport characteristic(s) between the high power RBS and the low power RBS. When the determined transport characteristic(s) are unfavourable, the method comprises transmitting 350 control information to the wireless device, the control information being transmitted on a second set of licensed frequency bands which is different from a first set of licensed frequency bands of the high power RBS. The method further comprises, when the determined transport characteristic(s) are favourable, refraining 320 from transmitting the control information to the wireless device allowing the high power RBS to transmit the control information on the first or the second set of licensed frequency bands.

When the low power RBS determines the transport characteristic(s) between the high power RBS and the low power RBS, it may simply receive an indication thereof from the high power RBS, or from a network node in the wireless communication network. Consequently, determining 310 transport characteristic(s) between the high power RBS and the low power RBS may not require performing active measurements by the low power RBS itself, but instead the low power RBS may receive information about the transport characteristic(s).

As described above, there are many possible definitions of transport characteristic(s) being favourable and unfavourable. The same definitions as described for the high power RBS apply for the low power RBS.

When the determined transport characteristic(s) are unfavourable, the low power RBS and the high power RBS may not communicate efficiently without too much delay. As described above, the high power RBS refrains from transmitting control information to the wireless device.

This means that it is up to the low power RBS to transmit 350 control information to the wireless device, the control information being transmitted on a second set of licensed frequency bands which is different from a first set of licensed frequency bands of the high power RBS. The low power RBS has access to, or controls, a second set of licensed frequency bands which is different from a first set of licensed frequency bands of the high power RBS. Consequently, the low power RBS sends the control information on the second set of licensed frequency band, which may be a Primary Serving Cell.

When the determined transport characteristic(s) are favourable, the low power RBS refrains 320 from transmitting the control information to the wireless device allowing the high power RBS to transmit the control information on the first or the second set of licensed frequency bands.

As described above, when the transport characteristic(s) are favourable, the high power RBS transmits 220 control information to the wireless device on a first set of licensed frequency bands or on a second set of licensed frequency bands being different than the first set of licensed frequency bands. Consequently, the low power RBS refrains 320 from transmitting the control information to the wireless device allowing the high power RBS to transmit the control information on the first or the second set of licensed frequency bands.

The method performed by the low power RBS has the same advantages as the method performed by the high power RBS. One possible advantage is that high indoor capacity may be maintained without negatively affecting the surrounding high power RBS capacity. The cost for deploying the indoor system (or number of indoor small cells) can be minimised since full indoor dominance is provided by using a small part of “dedicated” indoor spectrum. The solution provides coordination between high power RBS and low power RBS and it is achieved by serving indoor users in non-indoor dominance area using unlicensed spectrum. The reduction in efficiency of the licensed spectrum is minimised since the licensed spectrum is reused as efficiently as possible, considering the transport characteristic between baseband units.

The method may further comprise as illustrated in FIG. 3b, when the determined transport characteristic(s) are favourable: determining 330 a location of the wireless device. When the wireless device is located in an area associated with strong signal from high power RBS transmitting 340 data to the wireless device, the data is transmitted on a set of unlicensed frequency bands. FIG. 3b also comprises a box 335, which illustrates the low power RBS checking if the signal from the low power (LP) RBS is weak or not. As stated above, “weak signal from low power RBS” in the context of this disclosure means received signal strength of low power RBS signals <received signal strength of high power RBS signals=dominance problem, wherein the low power RBS may not achieve dominance in its cell, i.e. its coverage area. Consequently, the wireless device being located in an area associated with strong signal from high power RBS corresponds to the wireless device being located in an area associated with weak signal from low power RBS, corresponding to the wireless device being in an area with dominance problems. Thus, “strong signal” versus “weak” signal in this disclosure refers to the relationship between signals received from the low power RBS and the high power RBS.

By determining 330 the location of the wireless device means, in one embodiment, determining whether the wireless device is located in an area associated with dominance problems as described above. Hence, determining 330 the location of the wireless device may not necessarily be determining geographical coordinates, but rather whether the wireless devices is located in an area associated with dominance problems.

When the wireless device is located in an area that is associated with dominance problems, i.e. the wireless device may receive strong signals from the high power RBS and possibly also weak signals from the low power RBS, then transmissions on the licensed frequency bands may be susceptible to interference by the high power RBS. However, since the unlicensed frequency bands comprise different frequencies than the licensed frequency bands, transmissions from the low power RBS on the unlicensed frequency band may not be affected by transmissions from the high power RBS on the licensed frequency bands.

Consequently, the low power RBS transmits 340 data to the wireless device, the data is transmitted on a set of unlicensed frequency bands.

When the wireless device may receive weak or strong signals from the low power RBS and strong signals from the high power RBS, the low power RBS may utilise the unlicensed frequency bands in order to send data to the wireless device, since the transmissions are unlikely to be affected by e.g. interference from the high power RBS.

The method may further comprise, when the wireless device is located in an area associated with weak signal from the high power RBS, transmitting 345 data to the wireless device, the data being transmitted on the first or second set of licensed frequency bands or on the set of unlicensed frequency bands.

When the wireless device is located in an area that is not associated with dominance problems, i.e. the wireless device may receive weak signals from the high power RBS, transmissions from the low power RBS may not be susceptible to interference by the high power RBS. Consequently, the low power RBS may transmit data to the wireless device on the first or second set of licensed frequency bands or on the set of unlicensed frequency bands.

Since the wireless device is located in an area where it receives weak signals from the high power RBS, any transmission from the low power RBS is unlikely to be affected by interference from the high power RBS. Consequently, the low power RBS may use any of the first licensed frequency band, the second licensed frequency band and the unlicensed frequency bands for transmitting data to the wireless device.

Still further, the method may comprise, when the determined transport characteristic(s) are unfavourable, transmitting 360 data to the wireless device on any of the first set of licensed frequency bands, the second set of licensed frequency bands and/or the unlicensed frequency band.

In the scenario when the transport characteristic(s) are unfavourable, the high power RBS and the low power RBS may not communicate efficiently. Hence, the low power RBS should serve the wireless device in every respect, i.e. transmitting both control information and data to the wireless device.

The low power RBS transmits data to the wireless device on any of the frequency bands, i.e. the first licensed frequency band, the second licensed frequency band and the unlicensed frequency bands.

It shall be pointed out that a network node may determine the transport characteristics (e.g. delay) between the high power RBS and the low power RBS (e.g. between baseband units of the high power RBS and the low power RBS respectively) responsible for an indoor small cell and an outdoor macro cell causing lack of indoor dominance in an indoor area where an unlicensed frequency spectrum share is used only by the indoor small cell. The network node may be implemented in the high power RBS or in a node in e.g. an Operation, Administration and Maintenance, OAM, system or an Operation and Support System, OSS. Consequently, when the low power RBS determines the transport characteristics between the high power RBS and the low power RBS, it receives information about the transport characteristics from the network node. When the high power RBS determines the transport characteristics between the high power RBS and the low power RBS, it may perform various measurements if the network node is implemented in the high power RBS or it may receive the information in the same manner as the low power RBS if the network node is implemented in a node in an OAM system or a node in an OSS.

If the transport characteristic(s) is/are favourable (e.g. delay<predetermined limit), the first licensed frequency spectrum band may be used by both indoor small cell and macro cell, i.e. both the low power RBS and the high power RBS.

The problem with lack of indoor dominance is solved by serving data demand of “indoor users”, i.e. users of wireless devices located in a coverage area of the low power RBS, with the unlicensed frequency band in the area with dominance problem. The band is not used by the outdoor macro, i.e. the high power RBS, and there is hence no problem with dominance. Generally, an estimation of the signal strength from the surrounding macros may be required when deploying an indoor system. Signal strength measurements or predictions may be used to gather this data. The problem with lack of indoor dominance and macro causing the problem may be determined as part of this process.

A network node determines the transport characteristic(s) between the high power RBS and the low power RBS, e.g. between the baseband unit (digital unit, DU) of the indoor small cell and the baseband unit of the macro cell causing the strong macro signal. In the case when the same baseband unit is used for both the indoor small cell and the macro cell, then it is seen that the transport characteristics are favourable.

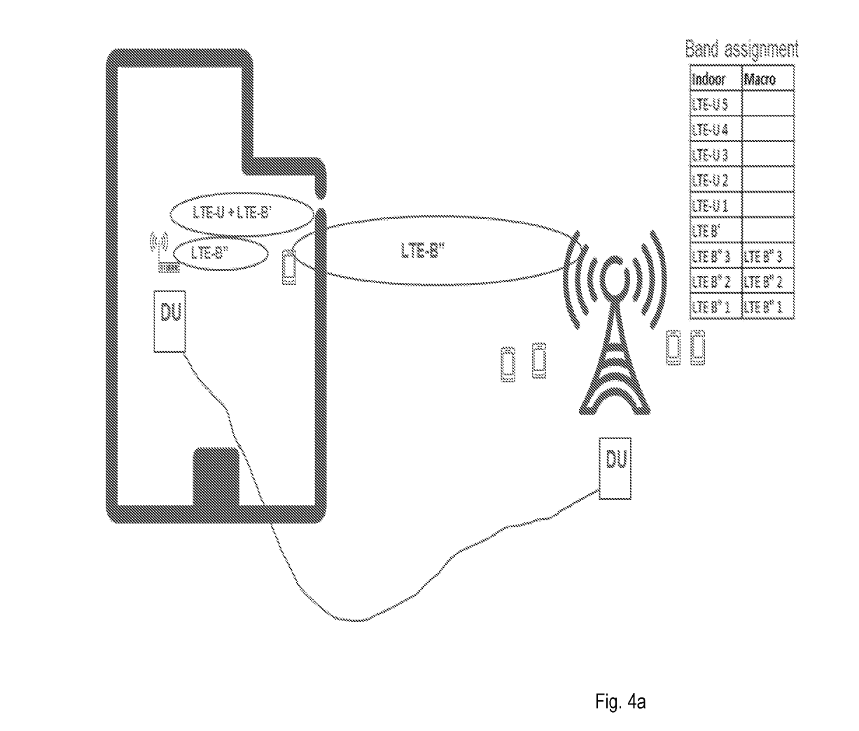

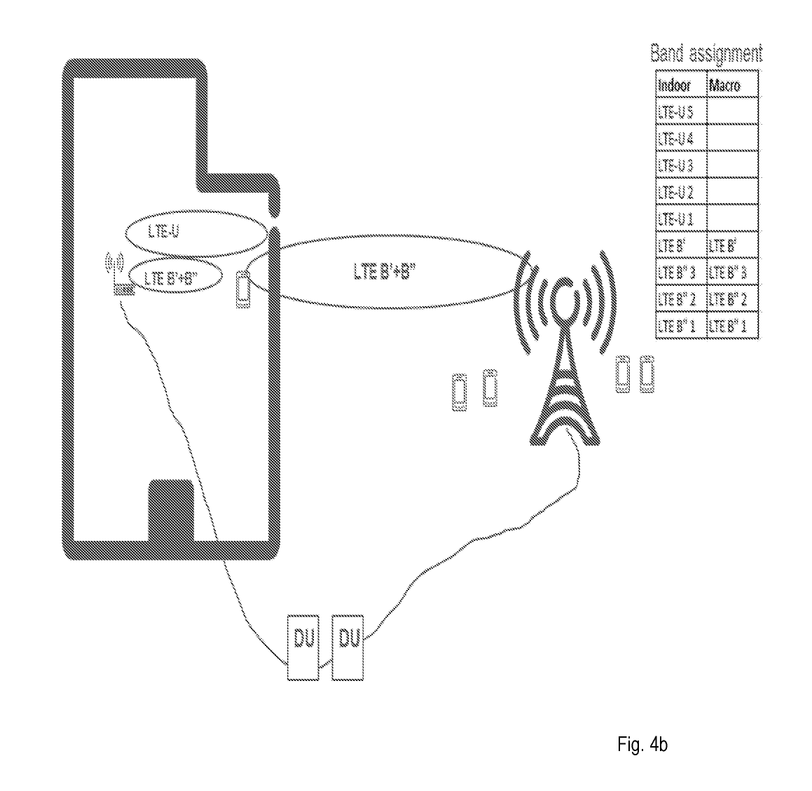

If the transport characteristics are unfavourable (e.g. large delay), the control signalling information for operating the unlicensed band must be conveyed on a licensed frequency band from the indoor small cell. This is secured by dedicating a small licensed spectrum part in the indoor small cells (LTE-B′), see FIG. 4a. In this case, there must also be a second licensed spectrum band allocated to the macro cell, e.g. LTE-B″. The second licensed spectrum band may be used in the indoor small cell. FIG. 4a shows this case for the wireless device, e.g. a UE, located in the problematic area where indoor dominance is otherwise challenging to achieve. In this case the wireless device is served by the indoor small cell and typically the PCell is on LTE-B′ (only deployed on indoor small cell) and SCell is on unlicensed band (shown as LTE-U in the figure and also only deployed on indoor small cell).

If the transport characteristic(s) are favourable (e.g. small delay, below a predetermined limit), the control signalling information for operating the unlicensed band may be sent on the licensed frequency band from the macro cell. In this case, the licensed band (LTE-B′) can be used by both macro and indoor small cells, increasing spectral efficiency, see FIG. 4b. FIG. 4b shows this case also for the wireless device located in the problematic area where indoor dominance is otherwise challenging to achieve. In this case the wireless device is served by both macro cell and the indoor small cell. Typically the PCell can be on LTE-B′/LTE-B″ (from the macro cell) and SCell is on unlicensed band from the small cell (shown as LTE-U in the figure).

In this case, there is a need to determine if a wireless device located in the indoor area where macro is stronger than indoor small cell can use the unlicensed spectrum for data transmissions. This can be achieved by using wireless device measurements reported to e.g. the high power RBS intended for e.g. handover purposes. Data intended for a wireless device is scheduled on the unlicensed spectrum if signal strength of indoor RBS is X dB weaker than the own signal. As a compliment, wireless device feedback information (channel quality indicator) can be used determine if the wireless device is e.g. inside or outside the building. If channel quality indicator (for unlicensed band) is too bad, data is scheduled on the licensed band from macro.

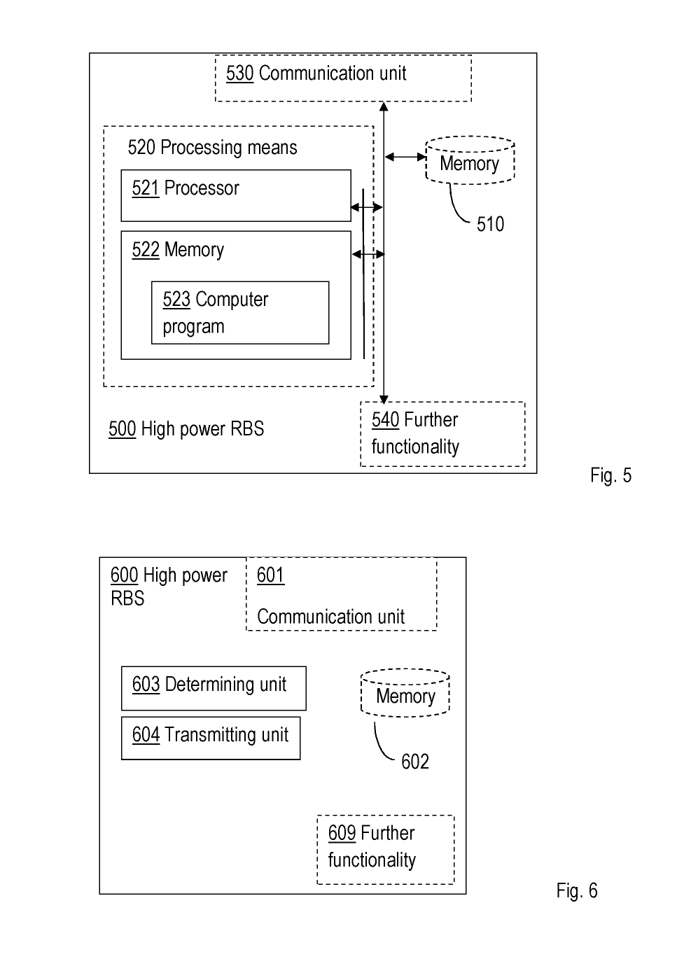

Embodiments herein also relate to a high power RBS for communicating with a wireless device. The high power RBS is operable in a wireless communication network supporting Carrier Aggregation and the high power RBS is associated with a low power RBS. The high power RBS has the same objects, technical features and advantages as the method performed by the high power RBS as described above. The high power RBS will only be described in brief in order to avoid unnecessary repetition. The high power RBS will be described with reference to FIGS. 5 and 6.

FIG. 5 is a block diagram of a high power RBS configured for communicating with a wireless device.

FIG. 6 is a block diagram of a high power RBS configured for communicating with a wireless device.

FIGS. 5 and 6 illustrate the high power RBS being configured for determining transport characteristic(s) between the high power RBS and the low power RBS. The high power RBS is further configured for, when the determined transport characteristic(s) are favourable, transmitting control information to the wireless device on a first set of licensed frequency bands or on a second set of licensed frequency bands being different than the first set of licensed frequency bands. The high power RBS is further configured for, when the determined transport characteristic(s) are unfavourable, the method comprises refraining from transmitting the control information to the wireless device on the second set of licensed frequency bands allowing the low power RBS to transmit the control information on the second set of licensed frequency bands.

The high power RBS may be realised or implemented in various ways. A first exemplifying realisation or implementation is illustrated in FIG. 5. FIG. 5 illustrates the high power RBS comprising a processor 521 and memory 522, the memory comprising instructions, e.g. by means of a computer program 523, which when executed by the processor 521 causes the high power RBS 500 to determining transport characteristic(s) between the high power RBS and the low power RBS. The memory further comprises instructions, which when executed by the processor 521 causes the high power RBS 500 to, when the determined transport characteristic(s) are favourable, transmitting control information to the wireless device on a first set of licensed frequency bands or on a second set of licensed frequency bands being different than the first set of licensed frequency bands. The memory further comprises instructions, which when executed by the processor 521 causes the high power RBS 500 to, when the determined transport characteristic(s) are unfavourable, refraining from transmitting data and the control information to the wireless device on the second set of licensed frequency bands allowing the low power RBS to transmit the control information on the second set of licensed frequency bands.

FIG. 5 also illustrates the high power RBS 500 comprising a memory 510. It shall be pointed out that FIG. 5 is merely an exemplifying illustration and memory 510 may be optional, be a part of the memory 522 or be a further memory of the high power RBS 500. The memory may for example comprise information relating to the high power RBS 500, to statistics of operation of the high power RBS 500, just to give a couple of illustrating examples. FIG. 5 further illustrates the high power RBS 500 comprising processing means 520, which comprises the memory 522 and the processor 521. Still further, FIG. 5 illustrates the high power RBS 500 comprising a communication unit 530. The communication unit 530 may comprise an interface through which the high power RBS 500 communicates with other nodes or entities, e.g. the low power RBS and the wireless device of the wireless communication network as well as other communication units. FIG. 5 also illustrates the high power RBS 500 comprising further functionality 540. The further functionality 540 may comprise hardware of software necessary for the high power RBS 500 to perform different tasks that are not disclosed herein.

An alternative exemplifying realisation, or implementation, of the high power RBS is illustrated in FIG. 6. FIG. 6 illustrates the high power RBS 600 comprising a determining unit 603 for determining transport characteristic(s) between the high power RBS and the low power RBS. FIG. 6 also illustrates the high power RBS 600 comprising a transmitting unit 604 for, when the determined transport characteristic(s) are favourable, transmitting control information to the wireless device on a first set of licensed frequency bands or on a second set of licensed frequency bands being different than the first set of licensed frequency bands. When the determined transport characteristic(s) are unfavourable, the transmitting unit 604 refrains from transmitting data and the control information to the wireless device on the second set of licensed frequency bands allowing the low power RBS to transmit the control information on the second set of licensed frequency bands.

In FIG. 6, the high power RBS 600 is also illustrated comprising a communication unit 601. Through this unit, the high power RBS 600 is adapted to communicate with other nodes and/or entities in the wireless communication network. The communication unit 601 may comprise more than one receiving arrangement. For example, the communication unit 601 may be connected to both a wire and an antenna, by means of which the high power RBS 600 is enabled to communicate with other nodes and/or entities in the wireless communication network. Similarly, the communication unit 601 may comprise more than one transmitting arrangement, which in turn is connected to both a wire and an antenna, by means of which the high power RBS 600 is enabled to communicate with other nodes and/or entities in the wireless communication network. The high power RBS 600 further comprises a memory 602 for storing data. Further, the high power RBS 600 may comprise a control or processing unit (not shown) which in turn is connected to the different units 603 and 604. It shall be pointed out that this is merely an illustrative example and the high power RBS 600 may comprise more, less or other units or modules which execute the functions of the high power RBS 600 in the same manner as the units illustrated in FIG. 6. Also FIG. 6 illustrates the high power RBS 600 comprising further functionality 609. The further functionality 609 may comprise hardware of software necessary for the high power RBS 600 to perform different tasks that are not disclosed herein.

It should be noted that FIG. 6 merely illustrates various functional units in the high power RBS 600 in a logical sense. The functions in practice may be implemented using any suitable software and hardware means/circuits etc. Thus, the embodiments are generally not limited to the shown structures of the high power RBS 600 and the functional units. Hence, the previously described exemplary embodiments may be realised in many ways. For example, one embodiment includes a computer-readable medium having instructions stored thereon that are executable by the control or processing unit for executing the method steps in the high power RBS 600. The instructions executable by the computing system and stored on the computer-readable medium perform the method steps of the high power RBS 600 as set forth in the claims.

The high power RBS has the same advantages as the method performed by the high power RBS. One possible advantage is that high indoor capacity may be maintained without negatively affecting the surrounding high power RBS capacity. The cost for deploying the indoor system (or number of indoor small cells) can be minimised since full indoor dominance is provided by using a small part of “dedicated” indoor spectrum. The solution provides coordination between high power RBS and low power RBS and it is achieved by serving indoor users in non-indoor dominance area using unlicensed spectrum. The reduction in efficiency of the licensed spectrum is minimised since the licensed spectrum is reused as efficiently as possible, considering the transport characteristic between baseband units.

According to an embodiment, the high power RBS is further configured for, when the determined transport characteristic(s) are favourable: determining a location of the wireless device, and when the wireless device is located in an area associated with weak signal from low power RBS: transmitting data to the wireless device, the data being transmitted on the first and/or second set of licensed frequency bands.

According to another embodiment, the high power RBS is further configured for, when the determined transport characteristic(s) are favourable: when the wireless device is located in an area associated with strong signal from the low power RBS: refraining from transmitting data to the wireless device allowing the low power RBS to transmit the data to the wireless device on a set of unlicensed bands.

According to yet an embodiment, the high power RBS is further configured for, when the determined transport characteristic(s) are unfavourable: refraining from transmitting data to the wireless device allowing the low power RBS to transmit the data to the wireless device.

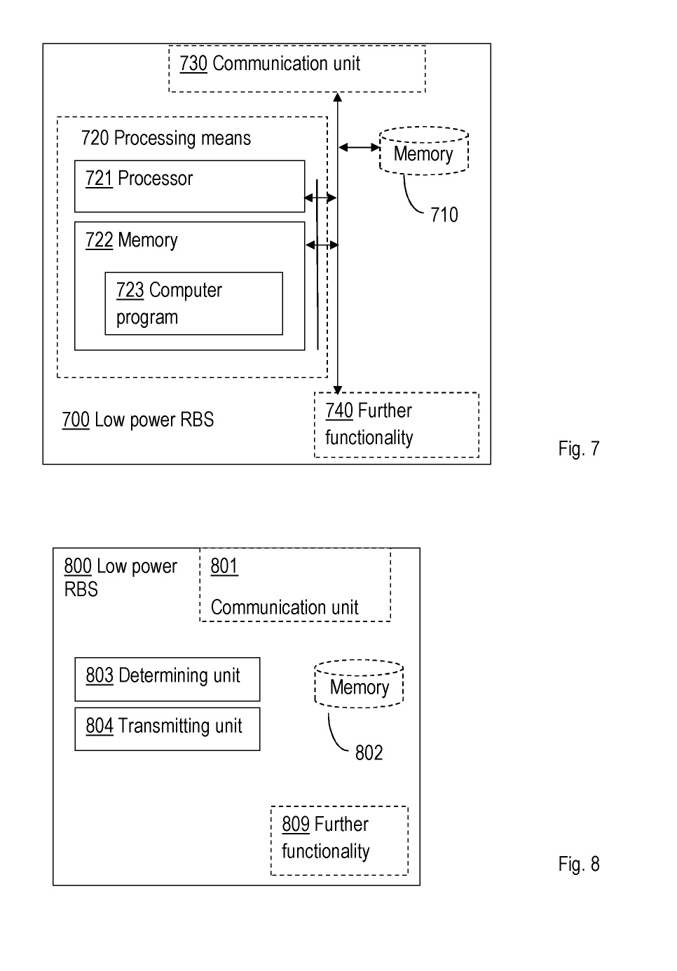

Embodiments herein also relate to a low power RBS for communicating with a wireless device. The low power RBS is operable in a wireless communication network supporting Carrier Aggregation and the low power RBS is associated with a high power RBS. The low power RBS has the same objects, technical features and advantages as the method performed by the high power RBS as described above. The low power RBS will only be described in brief in order to avoid unnecessary repetition. The low power RBS will be described with reference to FIGS. 7 and 8.

FIG. 7 is a block diagram of a low power RBS configured for communicating with a wireless device.

FIG. 8 is a block diagram of a low power RBS configured for communicating with a wireless device.

FIGS. 7 and 8 illustrate the low power RBS being configured for determining transport characteristic(s) between the high power RBS and the low power RBS. The low power RBS is further configured for, when the determined transport characteristic(s) are unfavourable, transmitting control information to the wireless device, the control information being transmitted on a second set of licensed frequency bands which is different from a first set of licensed frequency bands of the high power RBS. The low power RBS is further configured for, when the determined transport characteristic(s) are favourable, refraining from transmitting the control information to the wireless device allowing the high power RBS to transmit the control information on the first or the second set of licensed frequency bands.

The low power RBS may be realised or implemented in various ways. A first exemplifying realisation or implementation is illustrated in FIG. 7. FIG. 7 illustrates the low power RBS comprising a processor 721 and memory 722, the memory comprising instructions, e.g. by means of a computer program 723, which when executed by the processor 721 causes the low power RBS 700 to determining transport characteristic(s) between the high power RBS and the low power RBS. The memory further comprises instructions, which when executed by the processor 721 causes the low power RBS 700 to, when the determined transport characteristic(s) are unfavourable, transmit control information to the wireless device, the control information being transmitted on a second set of licensed frequency bands which is different from a first set of licensed frequency bands of the high power RBS. The memory further comprises instructions, which when executed by the processor 721 causes the low power RBS 700 to, when the determined transport characteristic(s) are favourable, refraining from transmitting the control information to the wireless device allowing the high power RBS to transmit the control information on the first or the second set of licensed frequency bands.

FIG. 7 also illustrates the low power RBS 700 comprising a memory 710. It shall be pointed out that FIG. 7 is merely an exemplifying illustration and memory 710 may be optional, be a part of the memory 722 or be a further memory of the low power RBS 700. The memory may for example comprise information relating to the low power RBS 700, to statistics of operation of the low power RBS 700, just to give a couple of illustrating examples. FIG. 7 further illustrates the low power RBS 700 comprising processing means 720, which comprises the memory 722 and the processor 721. Still further, FIG. 7 illustrates the low power RBS 700 comprising a communication unit 730. The communication unit 730 may comprise an interface through which the low power RBS 700 communicates with other nodes or entities, e.g. the high power RBS and the wireless device of the wireless communication network as well as other communication units. FIG. 7 also illustrates the low power RBS 700 comprising further functionality 740. The further functionality 740 may comprise hardware of software necessary for the low power RBS 700 to perform different tasks that are not disclosed herein.

An alternative exemplifying realisation, or implementation, of the low power RBS is illustrated in FIG. 8. FIG. 8 illustrates the low power RBS 800 comprising a determining unit 803 for determining transport characteristic(s) between the high power RBS and the low power RBS. FIG. 8 also illustrates the low power RBS 800 comprising a transmitting unit 804 for, when the determined transport characteristic(s) are unfavourable, transmitting control information to the wireless device, the control information being transmitted on a second set of licensed frequency bands which is different from a first set of licensed frequency bands of the high power RBS. When the determined transport characteristic(s) are favourable, the transmitting unit 804 refrains from transmitting the control information to the wireless device allowing the high power RBS to transmit the control information on the first or the second set of licensed frequency bands.

In FIG. 8, the low power RBS 800 is also illustrated comprising a communication unit 801. Through this unit, the low power RBS 800 is adapted to communicate with other nodes and/or entities in the wireless communication network. The communication unit 801 may comprise more than one receiving arrangement. For example, the communication unit 801 may be connected to both a wire and an antenna, by means of which the low power RBS 800 is enabled to communicate with other nodes and/or entities in the wireless communication network. Similarly, the communication unit 801 may comprise more than one transmitting arrangement, which in turn is connected to both a wire and an antenna, by means of which the low power RBS 800 is enabled to communicate with other nodes and/or entities in the wireless communication network. The low power RBS 800 further comprises a memory 802 for storing data. Further, the low power RBS 800 may comprise a control or processing unit (not shown) which in turn is connected to the different units 803 and 804. It shall be pointed out that this is merely an illustrative example and the low power RBS 800 may comprise more, less or other units or modules which execute the functions of the low power RBS 800 in the same manner as the units illustrated in FIG. 8. Also FIG. 8 illustrates the low power RBS 800 comprising further functionality 809. The further functionality 809 may comprise hardware of software necessary for the low power RBS 800 to perform different tasks that are not disclosed herein.

It should be noted that FIG. 8 merely illustrates various functional units in the low power RBS 800 in a logical sense. The functions in practice may be implemented using any suitable software and hardware means/circuits etc. Thus, the embodiments are generally not limited to the shown structures of the low power RBS 800 and the functional units. Hence, the previously described exemplary embodiments may be realised in many ways. For example, one embodiment includes a computer-readable medium having instructions stored thereon that are executable by the control or processing unit for executing the method steps in low power RBS 800. The instructions executable by the computing system and stored on the computer-readable medium perform the method steps of the low power RBS 800 as set forth in the claims.

The low power RBS has the same advantages as the method performed by the low power RBS. One possible advantage is that high indoor capacity may be maintained without negatively affecting the surrounding high power RBS capacity. The cost for deploying the indoor system (or number of indoor small cells) can be minimised since full indoor dominance is provided by using a small part of “dedicated” indoor spectrum. The solution provides coordination between high power RBS and low power RBS and it is achieved by serving indoor users in non-indoor dominance area using unlicensed spectrum. The reduction in efficiency of the licensed spectrum is minimised since the licensed spectrum is reused as efficiently as possible, considering the transport characteristic between baseband units.

According to an embodiment, the low power RBS is further configured for, when the determined transport characteristic(s) are favourable: determining a location of the wireless device, and when the wireless device is located in an area associated with strong signal from high power RBS transmitting data to the wireless device, the data being transmitted on a set of unlicensed frequency bands.

According to yet an embodiment, the low power RBS is further configured for, when the wireless device is located in an area associated with weak signal from the high power RBS transmitting data to the wireless device, the data being transmitted on the first or second set of licensed frequency bands or on the set of unlicensed frequency bands.

According to still an embodiment, the low power RBS is further configured for, when the determined transport characteristic(s) are unfavourable: transmitting data to the wireless device on any of the first set of licensed frequency bands, the second set of licensed frequency bands and/or the unlicensed frequency band.

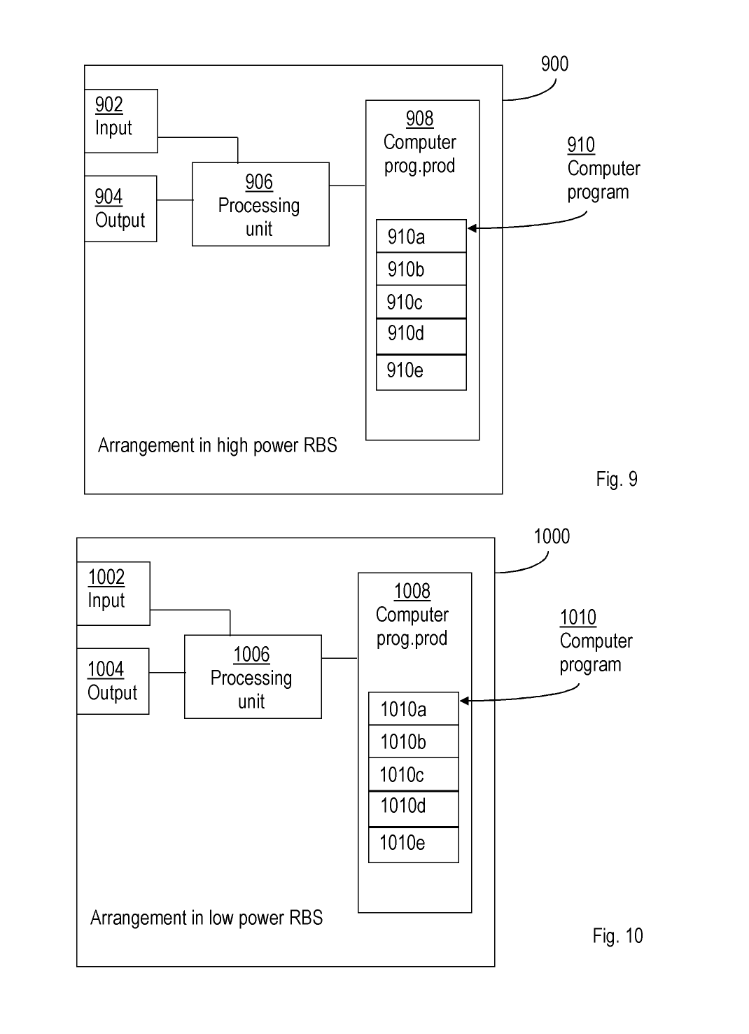

FIG. 9 schematically shows an embodiment of an arrangement 900 in a high power RBS 600. Comprised in the arrangement 900 in the high power RBS 600 are here a processing unit 906, e.g. with a Digital Signal Processor, DSP. The processing unit 906 may be a single unit or a plurality of units to perform different actions of procedures described herein. The arrangement 900 in the high power RBS 600 may also comprise an input unit 902 for receiving signals from other entities, and an output unit 904 for providing signal(s) to other entities. The input unit and the output unit may be arranged as an integrated entity or as illustrated in the example of FIG. 6, as one or more interfaces 601.

Furthermore, the arrangement 900 in the high power RBS 600 comprises at least one computer program product 908 in the form of a non-volatile memory, e.g. an Electrically Erasable Programmable Read-Only Memory, EEPROM, a flash memory and a hard drive. The computer program product 908 comprises a computer program 910, which comprises code means, which when executed in the processing unit 906 in the arrangement 900 in the high power RBS 600 causes the high power RBS to perform the actions e.g. of the procedure described earlier in conjunction with FIGS. 2a-2b.

The computer program 910 may be configured as a computer program code structured in computer program modules 910a-910e. Hence, in an exemplifying embodiment, the code means in the computer program of the arrangement 900 in the high power RBS 600 comprises a determining unit, or module, for determining transport characteristic(s) between the high power RBS and the low power RBS; and a transmitting unit, or module, for (i) when the determined transport characteristic(s) are favourable, transmitting control information to the wireless device on a first set of licensed frequency bands or on a second set of licensed frequency bands being different than the first set of licensed frequency bands; and for (ii) when the determined transport characteristic(s) are unfavourable, refraining from transmitting the control and data information to the wireless device on the second set of licensed frequency bands allowing the low power RBS to transmit the control information on the second set of licensed frequency bands.

The computer program modules could essentially perform the actions of the flow illustrated in FIGS. 2a-2b, to emulate the high power RBS 600. In other words, when the different computer program modules are executed in the processing unit 906, they may correspond to the units 603 and 604 of FIG. 6.

FIG. 10 schematically shows an embodiment of an arrangement 1000 in a low power RBS 800. Comprised in the arrangement 1000 in the low power RBS 800 are here a processing unit 1006, e.g. with a DSP. The processing unit 1006 may be a single unit or a plurality of units to perform different actions of procedures described herein. The arrangement 1000 in the low power RBS 800 may also comprise an input unit 1002 for receiving signals from other entities, and an output unit 1004 for providing signal(s) to other entities. The input unit and the output unit may be arranged as an integrated entity or as illustrated in the example of FIG. 8, as one or more interfaces 801.

Furthermore, the arrangement 1000 in the low power RBS 800 comprises at least one computer program product 1008 in the form of a non-volatile memory, e.g. an EEPROM, a flash memory and a hard drive. The computer program product 1008 comprises a computer program 1010, which comprises code means, which when executed in the processing unit 1006 in the arrangement 1000 in the low power RBS 800 causes the low power RBS 800 to perform the actions e.g. of the procedure described earlier in conjunction with FIGS. 3a-3c.

The computer program 1010 may be configured as a computer program code structured in computer program modules 1010a-1010e. Hence, in an exemplifying embodiment, the code means in the computer program of the arrangement 1000 in the low power RBS 800 comprises a determining unit, or module, for determining transport characteristic(s) between the high power RBS and the low power RBS. The code means in the computer program of the arrangement 900 in the wireless device further comprises a transmitting unit, or module, for (i) when the determined transport characteristic(s) are unfavourable, transmitting control information to the wireless device, the control information being transmitted on a second set of licensed frequency bands which is different from a first set of licensed frequency bands of the high power RBS; and for (ii) when the determined transport characteristic(s) are favourable, refraining from transmitting the control information to the wireless device allowing the high power RBS to transmit the control information on the first or the second set of licensed frequency bands.

The computer program modules could essentially perform the actions of the flow illustrated in FIGS. 3a-3c, to emulate the low power RBS 800. In other words, when the different computer program modules are executed in the processing unit 1006, they may correspond to the units 803 and 804 of FIG. 8.

Although the code means in the respective embodiments disclosed above in conjunction with FIGS. 6 and 8 are implemented as computer program modules which when executed in the respective processing unit causes the high power RBS and the low power RBS respectively to perform the actions described above in the conjunction with figures mentioned above, at least one of the code means may in alternative embodiments be implemented at least partly as hardware circuits.

The processor may be a single Central Processing Unit, CPU, but could also comprise two or more processing units. For example, the processor may include general purpose microprocessors; instruction set processors and/or related chips sets and/or special purpose microprocessors such as Application Specific Integrated Circuits, ASICs. The processor may also comprise board memory for caching purposes. The computer program may be carried by a computer program product connected to the processor. The computer program product may comprise a computer readable medium on which the computer program is stored. For example, the computer program product may be a flash memory, a Random-Access Memory RAM, Read-Only Memory, ROM, or an EEPROM, and the computer program modules described above could in alternative embodiments be distributed on different computer program products in the form of memories within the high power RBS and the low power RBS respectively.

It is to be understood that the choice of interacting units, as well as the naming of the units within this disclosure are only for exemplifying purpose, and nodes suitable to execute any of the methods described above may be configured in a plurality of alternative ways in order to be able to execute the suggested procedure actions.

It should also be noted that the units described in this disclosure are to be regarded as logical entities and not with necessity as separate physical entities.

While the embodiments have been described in terms of several embodiments, it is contemplated that alternatives, modifications, permutations and equivalents thereof will become apparent upon reading of the specifications and study of the drawings. It is therefore intended that the following appended claims include such alternatives, modifications, permutations and equivalents as fall within the scope of the embodiments and defined by the pending claims.

1. A method performed by a high power Radio Base Station, RBS, operable in a wireless communication network supporting Carrier Aggregation, the high power RBS being associated with a low power RBS, the method being performed for communicating with a wireless device, the method comprising:
determining one or more transport characteristics between the high power RBS and the low power RBS,
when the determined one or more transport characteristics are of a first level of favorability, transmitting control information to the wireless device on a first set of licensed frequency bands or on a second set of licensed frequency bands being different than the first set of licensed frequency bands, and
when the determined one or more transport characteristics are of a second level of favorability less favorable than the first level of favorability, refraining from transmitting the control information to the wireless device on the second set of licensed frequency bands allowing the low power RBS to transmit the control information on the second set of licensed frequency bands.

2. The method according to claim 1, further comprising when the determined one or more transport characteristics are of the first level of favorability:
determining a location of the wireless device, and when the wireless device is located in an area in which the low power RBS is not dominant:
transmitting data to the wireless device, the data being transmitted on the first and/or second set of licensed frequency bands.

3. The method according to claim 1, further comprising when the determined one or more transport characteristics are of the first level of favorability:
when the wireless device is located in an area in which the low power RBS is dominant:
refraining from transmitting data to the wireless device allowing the low power RBS to transmit the data to the wireless device on a set of unlicensed bands.

4. The method according to claim 1, further comprising when the determined one or more transport characteristics are of the second level of favorability:
refraining from transmitting data to the wireless device allowing the low power RBS to transmit the data to the wireless device.

5. A method performed by a low power Radio Base Station, RBS, operable in a wireless communication network supporting Carrier Aggregation, the low power RBS being associated with a high power RBS, the method being performed for communicating with a wireless device, the method comprising:
determining one or more transport characteristics between the high power RBS and the low power RBS,
when the determined one or more transport characteristics are of a first level of favorability, transmitting control information to the wireless device, the control information being transmitted on a second set of licensed frequency bands which is different from a first set of licensed frequency bands of the high power RBS, and
when the determined one or more transport characteristics are of a second level of favorability more favorable than the first level of favorability,
refraining from transmitting the control information to the wireless device allowing the high power RBS to transmit the control information on the first or the second set of licensed frequency bands.

6. The method according to claim 5, further comprising when the determined one or more transport characteristics are of the second level of favorability:
determining a location of the wireless device, and when the wireless device is located in an area in which the low power RBS is not dominant, transmitting data to the wireless device, the data being transmitted on a set of unlicensed frequency bands.

7. The method according to claim 6, further comprising, when the wireless device is located in an area in which the low power RBS is dominant, transmitting data to the wireless device, the data being transmitted on the first or second set of licensed frequency bands or on the set of unlicensed frequency bands.

8. The method according to claim 5, further comprising when the determined one or more transport characteristics are of the first level of favorability:
transmitting data to the wireless device on any of the first set of licensed frequency bands, the second set of licensed frequency bands and/or the unlicensed frequency band.

9. A high power Radio Base Station, RBS, operable in a wireless communication network supporting Carrier Aggregation, the high power RBS being associated with a low power RBS, the high power RBS being configured for communicating with a wireless device by being configured for:
determining one or more transport characteristics between the high power RBS and the low power RBS,
when the determined one or more transport characteristics are of a first level of favorability, transmitting control information to the wireless device on a first set of licensed frequency bands or on a second set of licensed frequency bands being different than the first set of licensed frequency bands, and
when the determined one or more transport characteristics are of a second level of favorability less favorable than the first level of favorability, refraining from transmitting the control information to the wireless device on the second set of licensed frequency bands allowing the low power RBS to transmit the control information on the second set of licensed frequency bands.

10. The high power RBS according to claim 9, further being configured for, when the determined one or more transport characteristics are of the first level of favorability:
determining a location of the wireless device, and when the wireless device is located in an area in which the low power RBS is not dominant:
transmitting data to the wireless device, the data being transmitted on the first and/or second set of licensed frequency bands.

11. The high power RBS according to claim 9, further being configured for, when the determined one or more transport characteristics are of the first level of favorability:
when the wireless device is located in an area in which the low power RBS is dominant:
refraining from transmitting data to the wireless device allowing the low power RBS to transmit the data to the wireless device on a set of unlicensed bands.

12. The high power RBS according to claim 9, further being configured for, when the determined one or more transport characteristics are of the second level of favorability:
refraining from transmitting data to the wireless device allowing the low power RBS to transmit the data to the wireless device.

13. A low power Radio Base Station, RBS, operable in a wireless communication network supporting Carrier Aggregation, the low power RBS being associated with a high power RBS, the low power RBS being configured for communicating with a wireless device, by being configured for:
determining one or more transport characteristics between the high power RBS and the low power RBS,
when the determined one or more transport characteristics are of a first level of favorability, transmitting control information to the wireless device, the control information being transmitted on a second set of licensed frequency bands which is different from a first set of licensed frequency bands of the high power RBS, and
when the determined one or more transport characteristics are of a second level of favorability more favorable than the first level of favorability, refraining from transmitting the control information to the wireless device allowing the high power RBS to transmit the control information on the first or the second set of licensed frequency bands.

14. The low power RBS according to claim 13, further being configured for, when the determined one or more transport characteristics are of the second level of favorability
determining a location of the wireless device, and when the wireless device is located in an area in which the low power RBS is not dominant, transmitting data to the wireless device, the data being transmitted on a set of unlicensed frequency bands.

15. The low power RBS according to claim 14, further being configured for, when the wireless device is located in an area in which the low power RBS is dominant, transmitting data to the wireless device, the data being transmitted on the first or second set of licensed frequency bands or on the set of unlicensed frequency bands.

16. The low power RBS according to claim 13, further being configured for, when the determined one or more transport characteristics are of the first level of favorability:
transmitting data to the wireless device on any of the first set of licensed frequency bands, the second set of licensed frequency bands and/or the unlicensed frequency band.

17. A Computer readable medium having stored thereon computer readable code, which when run in a processing unit comprised in an arrangement in a high power radio base station, RBS, associated with a low power RBS, causes the high power RBS to perform a method comprising:
determining one or more transport characteristics between the high power RBS and the low power RBS,
when the determined one or more transport characteristics are of a first level of favorability, transmitting control information to the wireless device on a first set of licensed frequency bands or on a second set of licensed frequency bands being different than the first set of licensed frequency bands, and
when the determined one or more transport characteristics are of a second level of favorability less favorable than the first level of favorability, refraining from transmitting the control information to the wireless device on the second set of licensed frequency bands allowing the low power RBS to transmit the control information on the second set of licensed frequency bands.

18. (canceled)

19. A Computer readable medium having stored thereon computer readable code, which when run in a processing unit comprised in an arrangement in a low power radio base station, RBS, associated with a high power RBS, causes the low power RBS to perform a method comprising:
determining one or more transport characteristics between the high power RBS and the low power RBS,
when the determined one or more transport characteristics are of a first level of favorability, transmitting control information to the wireless device, the control information being transmitted on a second set of licensed frequency bands which is different from a first set of licensed frequency bands of the high power RBS, and
when the determined one or more transport characteristics are of a second level of favorability more favorable than the first level of favorability, refraining from transmitting the control information to the wireless device allowing the high power RBS to transmit the control information on the first or the second set of licensed frequency bands.

20. (canceled)
